(19) United States
(12) Patent Application Publication
(10) Pub. No.: US 2017/0055484 A1
(43) Pub. Date: Mar. 2, 2017

(54) LITTER WITH AROMATIC AGENT FOR ATTRACTING A DOG

(71) Applicant: Scott Morey, Pleasanton, CA (US)

(72) Inventor: Scott Morey, Pleasanton, CA (US)

(21) Appl. No.: 14/837,953

(22) Filed: Aug. 27, 2015

(51) Int. Cl. A01K 1/015; A01K 15/02

(52) U.S. Cl. CPC A01K 1/0155; A01K 15/02

(57) ABSTRACT

A composition for a dog litter includes an aromatic agent for attracting a dog and a divided woody substrate. The color and texture of the dog litter and the divided woody substrate may be the same. An area designated for urination and/or defecation by a dog may be made attractive to the dog by dispersing the dog litter in the designated area. When a dog detects the aromatic agent, perhaps by smell or by direct contact with the treated woody substrate, the dog preferably perceives the designated area as the source of the aromatic agent and may be encouraged to urinate and/or defecate in the designated area. The aromatic agent preferably does not attract animal species other than dogs to the treated woody substrate. Some embodiments include steps for preparing the divided woody substrate and for preparing the designated area.

### FIELD OF THE INVENTION

Embodiments are related to animal litter, more particularly animal litter including woody material and an aromatic agent for attracting a dog to the litter.

### BACKGROUND

Numerous litter compositions, scented liquids, manufactured articles, and methods have been proposed to encourage a domesticated animal to defecate and urinate at a location chosen by a person responsible for caring for the animal. The chosen location may be selected to prevent damage to furnishings in a home, avoid destruction or discoloration of landscaping plants such as lawn grass or garden plants, for ease of cleaning, to train an animal to defecate and urinate at a time chosen by the animal's caretaker, to provide for sanitary collection and disposal of animal waste, or for other reasons.

Some litter compositions include a component to absorb and/or adsorb fluid components of animal waste. For example, litter may include cellulose, clay, or other material to cause the litter to clump when exposed to liquid, for example liquid in animal waste, to aid in separation of soiled and unused litter. However, litter compositions having a fluid-absorbing component may not be suitable for use in outdoor locations exposed to water from rainfall, sprinkler systems, or other sources of liquid which may fall on the litter and reduce the litter's utility for absorbing liquid from animal waste. Many absorbent litter compositions have a color or texture resembling sand, concrete, sawdust, or gravel. Absorbent litter compositions may have a color and texture which is easily distinguished from ground cover materials such as shredded bark, garden mulch, and the like, and may be aesthetically incompatible with decorative landscaping such as a lawn or garden. Some litter compositions may cause nearly as much damage to landscaping as may be caused by animal waste, perhaps by concentrating chemical compounds from animal waste into a small area or possibly by blocking sunlight and water from reaching plants used in landscaping.

Litter may be treated with a compound having a fragrance to mask odor from soiled litter and animal waste. Some litter compositions include a chemically reactive or biologically reactive agent for inhibiting unpleasant odors. A fragrance or reactive agent for reducing unpleasant odors may be washed away when the litter is exposed to rainfall or irrigation water.

Fragrances, reactive agents for controlling odor, absorbent materials, and compounds having a scent selected for attracting an animal may be combined with structural materials to form a manufactured article such as an absorbent pad or a porous, solid object. The manufactured article may fail to attract an animal if the fragrance or other active agent is expended, broken down by chemical action, inactivated by exposure to sunlight, or washed away from the article. Soiled pads may be disposed of in a landfill or incinerator, possibly leading to water and/or air pollution problems. An article may attract unwanted animals, for example wild animals or animals of a different species than a preferred animal, possibly increasing an amount of animal waste to be disposed of, exposing a domestic animal to a potential source of disease, causing more odor, expending water-absorbing or scent-producing properties of the article more quickly, and/or discouraging a preferred animal such as a family pet from defecating or urinating at a location chosen by the animal's caretaker.

A previous method for preventing damage to landscaping plants from animal waste includes preparing a designated area for animal urination and defecation by covering the designated area with a divided stony material such as sand, pebbles, or gravel. The stony covering material may be confined to the designated area by a surrounding frame or other low barrier that a small animal can easily step or climb over. Or, the designated area may include a washable solid surface made from concrete, bricks, paving stones, or the like. Solid animal waste may be sieved or lifted from the stony material in the designated area. The sand, pebbles, or solid surface may be washed with water to dilute animal urine and remove solid waste, but wash water with dissolved or suspended chemicals and particles may flow away from the designated area, possibly damaging landscaping plants or buildings or polluting groundwater or water in lakes or streams. The designated area and any associated barrier structures surrounding the designated area may take up valuable space in a small yard, may require the removal or destruction of lawn grass or other landscaping for installation of the divided stony material or solid surface, and may conflict with the aesthetic appearance of a lawn or garden. Odor-masking scents or scents for attracting an animal may be washed away when the area is sprayed or soaked with water or exposed to rainfall. An animal may kick stones or gravel out of the designated area into surrounding grass, possibly damaging surrounding landscaping or risking damage to maintenance equipment such as a lawnmower or edger. The materials forming the designated area may be difficult to clean and may be expensive to replace should the area become heavily soiled. It may be difficult or expensive to transport a sufficient weight of divided stony material to create a designated area large enough to accommodate an animal's behavior and needs.

### SUMMARY

Some embodiments comprise a composition for a dog litter, including a divided woody substrate, an aromatic agent attractive to a dog. The divided woody substrate and the aromatic agent may be combined to create a treated woody substrate. The treated woody substrate may be combines with non-treated divided woody substrate to create a mixture of treated and non-treated woody substrate.

The divided woody substrate may optionally comprise any one or more of landscaping bark, wood chips, and shredded bark, singly or in any combination. In some embodiments, the treated woody substrate and the divided woody substrate may have a same color and a same texture. In some embodiments, the aromatic agent comprises an animal gland extract. In some embodiments, the aromatic agent is capable of attracting a dog to a perceived source of the aromatic agent.

Other embodiments comprise a method. A method embodiment may include applying an aromatic agent attractive to a dog to a divided woody substrate to create a treated woody substrate; dispersing the treated woody substrate into a designated area; removing soiled treated woody substrate from the designated area; and replacing soiled treated woody substrate with unsoiled treated woody substrate.

### BRIEF DESCRIPTION OF THE DRAWINGS

FIG. 1 shows an example of a dog standing on an embodiment dispersed in a designated area with prohibited areas near the designated area.

FIG. 2 shows a block diagram of an example of a method embodiment.

FIG. 3 shows examples of optional steps for the example of a method embodiment of FIG. 2.

### DESCRIPTION

An aromatic agent attractive to dogs may be applied to a divided woody substrate to form a treated woody substrate for use as a dog lifter. The treated woody substrate, which may also be referred to herein as dog litter, may be dispersed outdoors to attract a dog to a designated area and to encourage the dog to urinate or defecate in the designated area. Soiled dog litter may be easily collected for removal from the designated area and may be replaced inexpensively with more treated woody substrate. In addition to the aromatic agent attractive to dogs, a dog litter embodiment may further include any one or more of a fragrance for masking unpleasant odors from soiled dog litter, a chemical and/or a biological agent for inhibiting the release of unpleasant odors from soiled dog litter, and a chemical and/or biological agent for improving the conversion of soiled dog litter to garden mulch.

Embodiments are effective for preventing damage from liquid and/or solid animal waste to landscaping plants such as trees, shrubbery, flowers, and lawns, and plants used as a food source by people. By attracting a dog to a designated area outdoors for urination and defecation, the dog may become trained to avoid urination and defecation in nearby prohibited areas such as lawns, garden beds, or interior spaces in buildings. Unlike previously known litter materials, for example litter materials having a substantial clay component, a dog litter embodiment comprising the treated woody substrate may be have a same color and a same texture as other garden mulch materials, for example the untreated woody substrate from which the treated woody substrate is made by application of the aromatic agent. More specifically, a person may be unable to perceive with unaided vision a color difference or texture difference between the treated and untreated substrate materials. Previously available litter compositions may have a visual appearance which differs substantially from the visual appearance of woody garden mulch materials such as chipped or shredded tree bark, wood chips, and the like.

An aromatic agent in accord with an embodiment may cause a dog to search for and move to a source location of the aromatic agent for defecation and/or urination. The source location for the aromatic agent will preferably be in the designated area. The aromatic agent may optionally be selected to avoid attracting any animal species other than a dog (canis familiaris) to the designated area. A dog may detect the aromatic agent by smelling the agent after it has dispersed in the air, or possibly by coming into direct physical contact with the aromatic agent on the dog litter.

As used herein, an aromatic agent refers to a volatile compound that may be detected by a dog's sense of smell. The aromatic agent preferably does not cause a color change or texture change in the treated woody substrate compared to untreated woody substrate. The aromatic agent preferably evaporates into the air very slowly after being applied to the divided woody substrate so that it lasts a long time. The aromatic agent preferably evaporates into thereby enabling detection of the aromatic agent by a dog's olfactory sense while the dog is some distance away from the designated area where the treated woody substrate has been dispersed.

An example of an acceptable aromatic agent in accord with an embodiment has been marketed by the National Scent Company Inc. as a housebreaking scent as described on a product safety data sheet identified by product code N72700. Aromatic agents for attracting a dog to a designated location or object may be available from other sources. Other preparations may be combined in an embodiment with the aromatic agent for attracting a dog, for example but not limited to preparations for absorbing odor, training sprays, powders, or liquids for conditioning a dog to urinate or defecate at a selected location, preparations for forming a colored visual target to attract a dog, and so on, none of which have previously been applied with an aromatic agent for attracting a dog to a divided woody substrate as for the embodiments described herein.

As used herein, a woody substrate refers to a part of a plant that produces wood for structural tissue. Examples of a woody substrate include, but are not limited to, wood chips, bark, fruit or nut husks, pits, seeds, or shells, cocoa bean shells, walnut shells, crushed or shredded coconut husks, shredded bark, landscaping bark, and similar divided woody materials which may be used for ground cover or mulch in landscaping. A divided material is one that has been cut, crushed, broken, or ripped into chunks, strips, fragments, or splinters. For the embodiments herein, individual pieces of a bulk volume of a divided woody substrate are preferably smaller, on average, than about five inches across a largest dimension of one piece of substrate material.

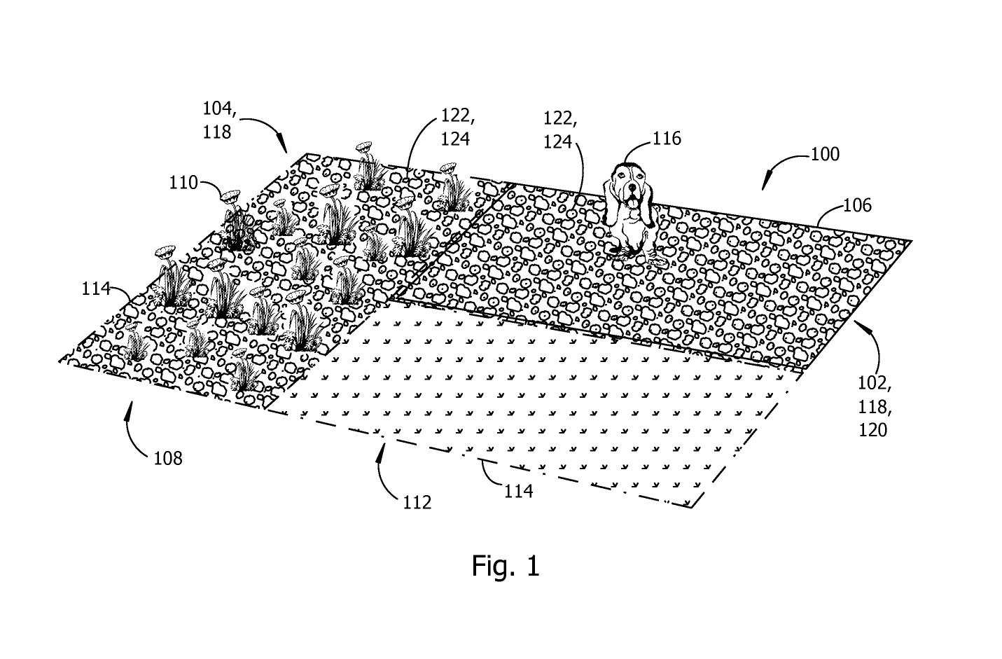

FIG. 1 illustrates an example of an embodiment 100 dispersed on the ground to create a preferred area designated by a dog's caretaker for urination or defecation by the dog. In the example of FIG. 1, an area of land is divided into a designated area 106 and at least one prohibited area 114. A dog 116 preferably selects the designated area 106 for urination and/or defecation and avoids urinating or defecating in prohibited areas. Examples of prohibited areas 114 include, but are not limited to, a garden area 108 having landscaping plants 110 or plants for human consumption which may be damaged or made unsafe for consumption by exposure to animal waste, a flower bed, an area having plants which may be toxic, sharp, or otherwise dangerous or unhealthy for a dog to touch or ingest, a grassy lawn area 112, and any other area or structure selected by a dog's caretaker.

The dog may select the designated area 106 after detecting an aromatic agent 120 released from a treated woody substrate 102 into the air, or possibly by coming into direct contact with the aromatic agent on the treated woody substrate. The designated area 106 may be perceived by the dog as the source of the aromatic agent 120.

The treated woody substrate may be formed by applying the aromatic agent 120 externally to a divided woody substrate 118, possibly by spraying a liquid including the aromatic agent onto the divided woody substrate, or soaking the substrate a liquid including the aromatic agent. The aromatic agent 120 preferably remains effective for attracting a dog when exposed to sunlight, moisture, and temperature conditions expected for a geographic region where an embodiment is to be used. In some preferred embodiments, the aromatic agent 120 is applied to the substrate 102 before packaging and distribution to users. However, aromatic agent 120 may optionally be applied to treated woody substrate 102 by the user before dispersal, or alternatively after the woody substrate has been dispersed in a designated area 106. A color 122 and a texture 124 of the treated woody substrate 102 and the untreated divided woody substrate 118 are preferably the same. It may be necessary for the aromatic agent 120 to dry after being applied to the divided woody substrate 118 for the color 122 and texture 124 of the treated and untreated substrates to have a same visual appearance.

In contrast to previously known litter materials, efficacy of an embodiment does not depend on absorption or adsorption of fluids from animal waste products by the divided woody substrate 118 in the treated woody substrate 102. In some embodiments fluids simply pass through the woody substrate 102. Soiled treated woody substrate 102 may simply be picked up and discarded along with animal waste. A dog litter in accord with an embodiment is preferably inexpensive compared to other forms of dog litter, so incidental amounts of unsoiled litter may be picked up and discarded with soiled litter and animal waste at little expense.

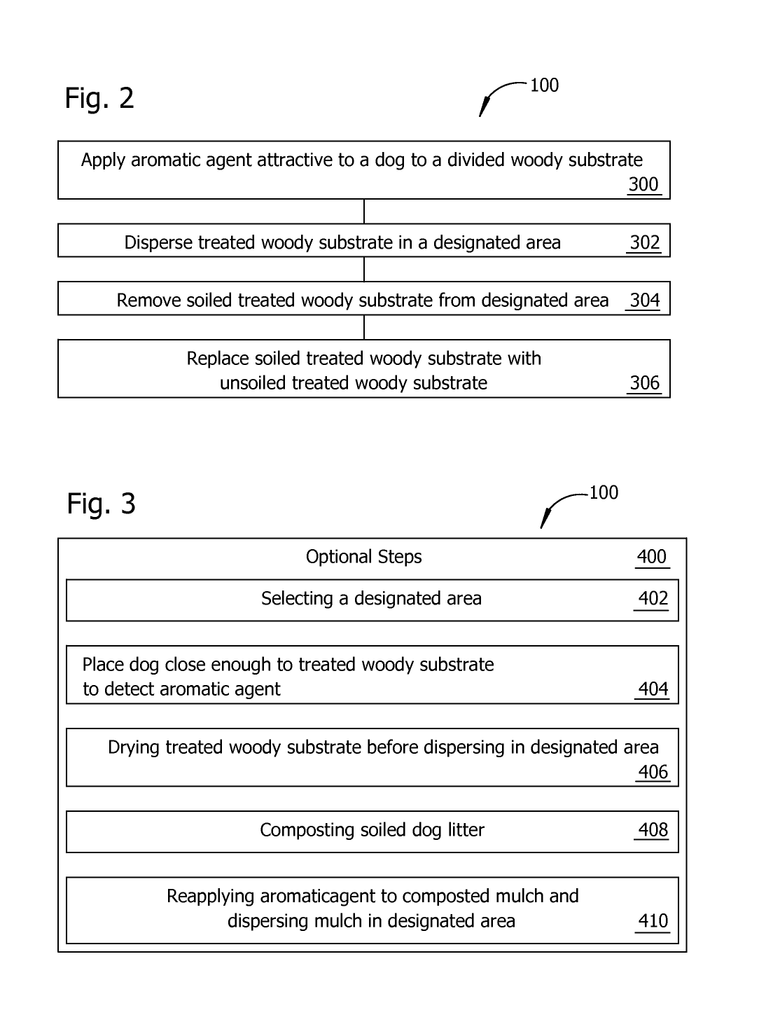

FIG. 2 shows an example of steps in a method embodiment. The method embodiment 100 includes at step 300 applying an aromatic agent attractive to a dog to a divided woody substrate. At step 302, the treated woody substrate is dispersed in a designated area. The designated area may refer to an area selected by a dog's caregiver where the dog is encouraged to urinate and/or defecate.

At step 304, soiled treated woody substrate may be removed from the designated area, where soiled treated woody substrate may refer to treated woody substrate that has been exposed to an animal's liquid and/or solid waste. At step 306, soiled treated woody substrate may be replaced with unsoiled treated woody substrate.

The example of a method embodiment 100 may include optional steps as suggested in the example of FIG. 3. Optional method steps 400 include any one or more of 402 selecting a designated area, 404 placing a dog close enough to treated woody substrate for the dog to detect the aromatic agent, 406 drying treated woody substrate before dispersing the treated woody substrate in the designated area, 408 composting soiled dog litter to form composted mulch, and 410 reapplying the aromatic agent to the composted mulch and dispersing the mulch in the designated area.

Unless expressly stated otherwise herein, ordinary terms have their corresponding ordinary meanings within the respective contexts of their presentations, and ordinary terms of art have their corresponding regular meanings.

What is claimed is:

1. A composition for a dog litter, comprising:
a treated woody substrate comprising:
a divided woody substrate; and
an aromatic agent attractive to a dog.

2. The composition of claim 1, wherein said divided woody substrate comprises landscaping bark.

3. The composition of claim 1, wherein said divided woody substrate comprises wood chips.

4. The composition of claim 1, wherein said divided woody substrate comprises shredded bark.

5. The composition of claim 1, wherein said treated woody substrate and said divided woody substrate have a same color.

6. The composition of claim 1, wherein said treated woody substrate and said divided woody substrate have a same texture.

7. The composition of claim 1, wherein said aromatic agent comprises an animal gland extract.

8. The composition of claim 7, wherein said aromatic agent comprises propylene glycol mixed with said animal gland extract.

9. A method, comprising:
applying an aromatic agent attractive to a dog to a divided woody substrate to create a treated woody substrate;
dispersing the treated woody substrate into a designated area;
removing soiled treated woody substrate from the designated area; and
replacing soiled treated woody substrate with unsoiled treated woody substrate.

10. The method of claim 9, further comprising placing a dog sufficiently close to the treated woody substrate to enable the dog to detect the aromatic agent.

11. The method of claim 9, further comprising selecting the designated area.

12. The method of claim 9, further comprising drying the treated woody substrate before dispersing the treated woody substrate in the designated area.

13. The method of claim 9, further comprising applying the aromatic agent to the divided woody substrate after dispersing the divided woody substrate in the designated area.

14. The method of claim 9, further comprising composting the soiled treated woody substrate to form composted mulch.

15. The method of claim 14, further comprising dispersing the composted mulch near landscaping plants.

16. The method of claim 9, further comprising the dog selecting the treated woody substrate in the designated area for a location for urination and/or defecation.

17. The method of claim 16, further comprising the dog avoiding urination and/or defecation outside the designated area.

18. The method of claim 1, further comprising selecting the aromatic agent to avoid attracting any animal species other than a dog.

19. A dog litter, comprising:
a divided woody substrate having a color and a texture;
an aromatic agent attractive to a dog, comprising an animal gland extract mixed with propylene glycol; and
a treated woody substrate comprising said aromatic agent applied to said divided woody substrate, said treated woody substrate having said color and said texture for said divided woody substrate,
wherein said aromatic agent is capable of attracting a dog to said treated woody substrate, and animal species other than a dog are not attracted by said aromatic agent to said woody substrate.
